(19) United States
(12) Patent Application Publication
(10) Pub. No.: US 2003/0206500 A1
(43) Pub. Date: Nov. 6, 2003

(54) Apparatus and method for aquisition of compact disc information for a compact disc/digital radio

(76) Inventor: Burc A. Simsek, Houston, TX (US)

Correspondence Address: TEXAS INSTRUMENTS INCORPORATED, P O BOX 655474, M/S 3999, DALLAS, TX, 75265

(21) Appl. No.: 10/137,997

(22) Filed: May 3, 2002

(51) Int. Cl. H04H 9/00

(52) U.S. Cl. 369/7

(57) ABSTRACT

A compact disc player unit includes has a digital radio receiver unit. A compact disc identifier along with a user identifier is transferred to a radio broadcast station. The broadcast station includes a database of compact disc information. The information associated with the compact disc identifier is retrieved from the database. The retrieved information, along with the user identifier, is broadcast by the station. The digital radio receiver unit accepts the retrieved information when accompanied by the user identifier. The accepted compact disc information is stored in a local memory unit. In response to the disc identifier and a track identifier generated by the compact disc player, data concerning an accessed disc track can be provided to the user by a visual display and/or by the speaker unit.

### BACKGROUND OF THE INVENTION

1. Field of the Invention

This invention relates generally to compact disc/digital radio receiver units and, more particularly, to the acquisition of compact disc-related information. The related information can include artist information, title information, and other disc-related information that may be of interest to the listener.

2. Background of the Invention

The advent of the digital radio receiver, and especially, the programmable digital radio receiver has provided new capabilities not possible in earlier apparatus. In the past, radio receivers and compact disc units have been included in single units packages with little integration of the two components aside from the use of a common speaker system. In the future, digital radio receivers will be combined with compact disc players as the availability of the digital radio receiver increases. The combined units can provide expanded functionality for the user by utilizing the digital information that can be received by the digital radio. The manufacturers can utilize a programmable digital radio solution to integrate these new features and create cost, power and space optimized designs.

It is known in the prior art to provide compact discs that have the disc information (e.g., compact disc text) encoded as part of, or in association with, the content audio tracks. Referring to FIG. 1A, a compact disc player unit 10 that can take advantage of the encoding of disc content information on the compact disc is shown. The compact disc player unit 10 includes compact disc player 101 that provides an access to the information encoded on the disc. The disc player 101 includes a control unit 102 and an audio processing unit 103. The control unit 102 can read the encoded data on the compact disc 5 and can cause the control and data information to be sent to the audio processing unit 103. The data information applied to the audio processing unit 103 is decoded and applied to the speaker unit 104. Disc content information that is retrieved by control unit 102, can be applied to the display portion 1051 of the user interface unit 105. The user interface 105 includes a manual input 1052 to control the operation of the compact disc unit 10. While this system can provide the user with the desired information, at the present time, few compacts discs are provided with text-encoded compact disc content information. In view of the lack of appropriate media, the compact disc content information is not generally available to a user with this technique even when the compact disc unit has the capability for displaying the information.

In order to circumvent the problem of the lack of availability of text-encoded compact discs, a second technique for displaying compact disc content information has been used. Referring to FIG. 1B, a compact disc player unit 15 that can be used to provide disc content information is shown. In this compact disc player unit 15, the disc content information is not available on the compact disc 5 itself. However, the compact disc 5 can have a compact disc-identifying signal group encoded thereon by, for example, the table of contents or the digital data of the tracks themselves. In this configuration, when a disc 5 is inserted in the compact disc player 151, portions of the disc 5 is read by the control unit 152. The control unit 152 can then extract the disc-identifying information. The extracted disc-identifying information can then be used to access a database or tables stored in local memory unit 156. The memory unit 156 stores the disc content information, indexed by the disc-identifying information. The disc content information can then be applied to the display 1551 in the user interface 155. This technique requires that a relatively large database be stored in the memory unit 156 because of the large number of different compact discs that can be accessed by the compact disc player 151. This large database is necessary even though the user may be interested in a relatively small subset of the available compact discs. In addition, some process for updating the database to accommodate recently issued compact discs must be provided. Moreover, when the compact disc player 151 is included in a portable unit, the ability to update the database is even more problematic.

A need has therefore been felt for apparatus and an associated method having the feature that compact disc information can be provided to a user of a compact disc player unit included as part of a portable unit. It would be another feature of the apparatus and associated method that the portable unit having the compact disc player include digital radio receiver. It would be yet another feature of the apparatus and associated method that the portable unit including the disc player unit includes a local memory unit and data processing capability. It would be yet another feature of the apparatus and associated method to provide the capability of acquiring and storing data related to a compact disc currently being accessed in a portable compact disc player unit. It would be a still further feature of the present invention to permit the portable compact disc player to have access to a large database of compact disc related information.

### SUMMARY OF THE INVENTION

The aforementioned and other features are accomplished, according to the present invention, by including with the compact disc player a digital radio receiver. A memory unit and processing capability are present in the digital radio receiver. The compact disc player unit through interaction with the compact disc, or the user, identifies the compact disc being accessed. An identifier signal group associated with the compact disc along with a user identifier is sent to central location. The central location includes a database with information related to compact disc identified by the compact disc identifier. The information related to the identified compact disc along with the used identifier is transmitted by the central location. The digital radio receiver unit associated with the compact disc player unit responds to the user identifier in the transmitted signal and stores the transmitted compact disc information. The processing unit associated with the digital radio receiver unit, in response to (track) signals from the compact disc player, can apply track and disc information to a display unit included in the compact disc player. According to a second embodiment of the invention, the radio station can broadcast signals relating to compact disc information for a large number of compact discs. The digital radio receiver unit can store the broadcast disc content information and a disc identifier from encoder on the compact disc can be used to retrieve the appropriate compact disc content information.

Other features and advantages of present invention will be more clearly understood upon reading of the following description and the accompanying drawings and the claims.

### BRIEF DESCRIPTION OF THE DRAWINGS

FIG. 1A is a block diagram of a first embodiment of a compact disc player unit with the capability to display compact disc information according to the prior art, while FIG. 1B is second embodiment of a compact disc player with the capability to display compact disc information according to the prior art.

FIG. 2 is a block diagram of compact disc player unit and associated apparatus capable of displaying compact disc information according to the present invention.

### DESCRIPTION OF THE PREFERRED EMBODIMENT

1. Detailed Description of the Figures

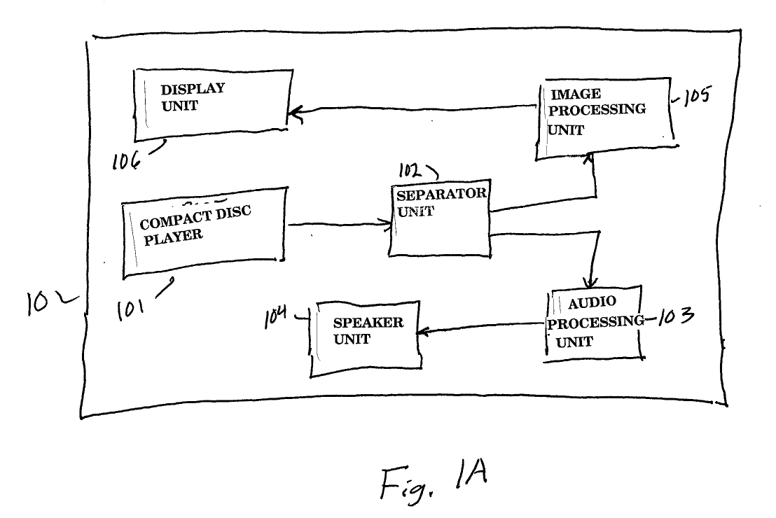

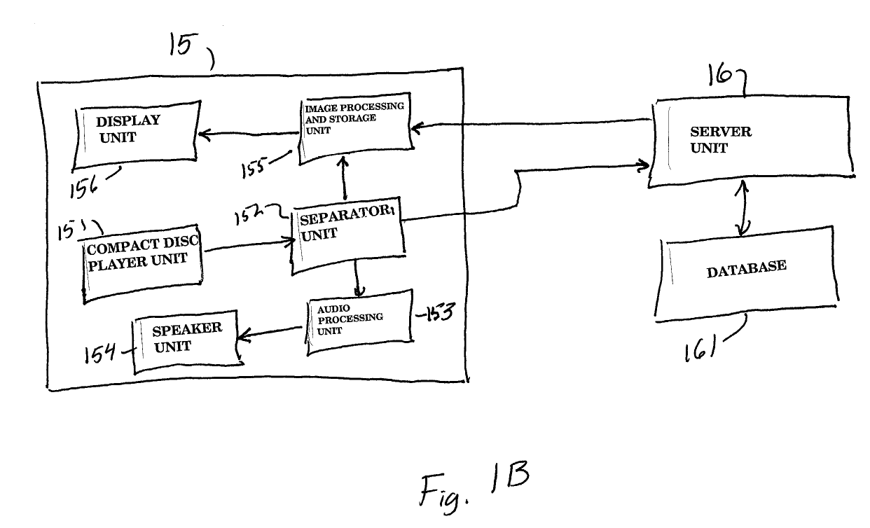

FIG. 1A and FIG. 1B have been described with respect to the related art.

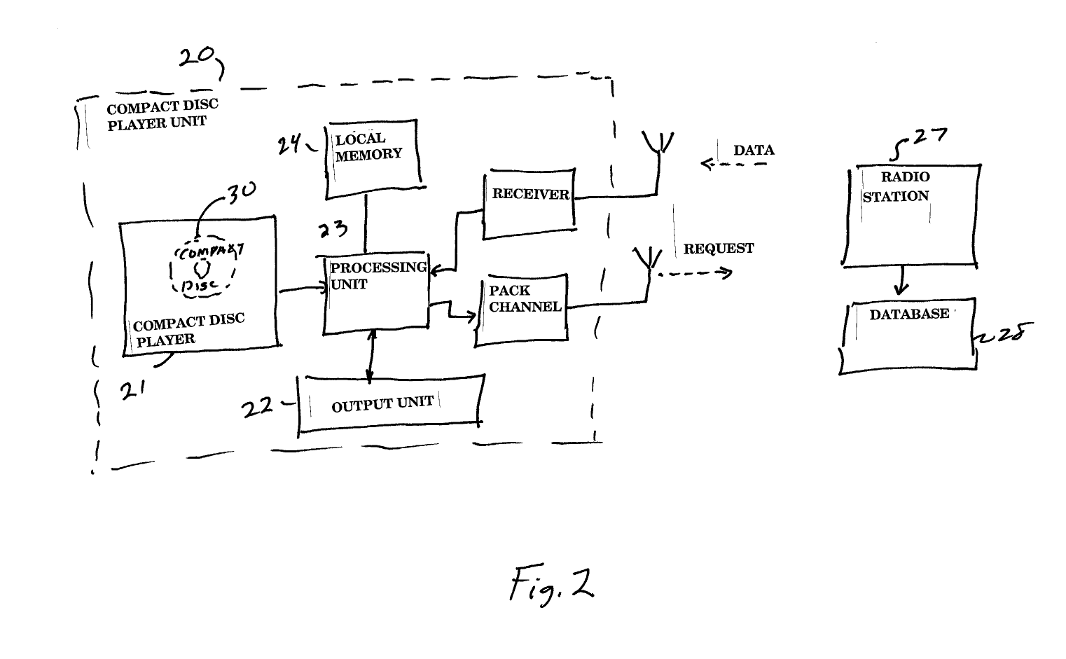

Referring next to FIG. 2, a compact disc player system according to the present invention is shown. A compact disc player 21 accesses a compact disc 5. As part of the access of the compact disc 5, a compact disc identifier is retrieved. The compact disc identifier is applied to control unit 23. The control unit 23 accesses the local memory 24 to determine whether any data indexed by the compact disc identifier is stored therein. When compact disc data is stored in the local memory unit 24, then at least a portion of this data is applied to the display 221 of the user interface 22.

When no compact disc data is available in memory unit 24 for the retrieved compact disc identifier, the control unit 23 applies the compact disc identifier along with a user identifier to the back channel 26. These two identifiers are formatted in such a way as to be a request for data. This request for data is applied by means of the back channel 26 to the radio station 27. Upon receipt of the request for information over the back channel 26, the radio station 27 verifies the identity of the requester and retrieves data from the database 28, the data being indexed by the compact disc identifier. After retrieval of the data associated with the compact disc identifier, the compact disc data is transmitted by the radio station 27 by means of a broadcast transmission. The broadcast transmission includes the user identifier and is formatted with conditional access in order that only the requesting user can receive the broadcast data. The broadcast transmission is received by the receiver unit 25 and is applied to control unit 23. The control unit 23 determines whether the user identifier in the broadcast transmission is the user identifier associated with the compact disc player unit 20. When the user identifier is not the identifier associated with compact disc player unit 20, the broadcast transmission is ignored. When the broadcast transmission is associated with the compact disc player unit 20, then the data, or a portion thereof, is applied to the display 221 of the user interface 22. In addition, the compact disc data is stored in the local memory 24 for future reference. In this manner, the compact disc data is available when a compact disc 5 with that compact disc identifier is again accessed by the compact disc player 21.

2. Operation of the Preferred Embodiment

The apparatus of the present invention allows a user of compact disc to obtain information concerning the compact disc in a more efficient manner than is permitted by the prior art. Information typically of interest to the user of compact disc includes artist, song title, etc. In the foregoing description, the information is described as being in a format suitable for visual display. As will be clear, with the processing capability included as part of the compact disc player (namely the programmable digital radio), the compact disc data can be in a form suitable for visual presentation or can be translated into a form suitable for audio presentation on the speaker unit 30.

In addition, most or all of the processing across the various units can be implemented by the free processing power of a programmable digital radio chip. The digital radio chip has sufficient processing power to perform the processing functions required for the present invention. In case of either the digital radio chip or a more elaborate processing unit, the compact disc player unit of the present invention has the flexibility of being programmable. In this manner, the user identifier can be selected by the user and, where necessary, the frequency of a local radio station generating the broadcast transmission can be programmed in the digital radio chip.

The communication from the compact disc player unit 20 to the radio station is accomplished by means of the back channel 26. In FIG. 2, this back channel is illustrated by a radio link. The present invention is not meant to be limited in this manner. Any means of communicating the request for compact disc data along with user identifier can be used. For example, a cell phone link, an Internet link, etc. can be used to provide the back channel 26.

In the situations where no back channel is available, the broadcaster may choose to set aside a portion of the data channel to broadcast a carousel of compact disc information. This carousel of information can permit the users to store local copies, copies that will be available for compact disc information look-ups. In this embodiment, the access to information may take a long time because no request is implemented to which the broadcast is a response. However, the radio-receiving units can create and update the local copies of the database during inactive and standby modes of operation, thereby making the operation transparent to the user.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A compact disc player unit, the unit comprising:
a compact disc player, the compact disc player including apparatus to retrieve a compact disc identifier from a compact disc;
apparatus for generating a compact disc identifier signal group and a user identifier signal group;
a radio receiver for receiving broadcast transmissions; and
a processing apparatus for identifying a broadcast transmission including the user identifier, the processing apparatus storing compact disc data in a broadcast transmission associated with the user identifier.

2. The unit as recited in claim 1 further comprising an output unit, the processing apparatus applying compact disc data stored by the processing unit to the output unit in response to signals from the compact disc player.

3. The unit as recited in claim 2 wherein the output device is selected from the group consisting of a display unit and a speaker unit.

4. The unit as recited in claim 2 wherein the signals from the compact player unit to processing apparatus identify the compact disk and the track of the compact disc being accessed by the compact disc player.

5. The unit as recited in claim 1 wherein the radio receiver and the processing apparatus are included in a digital radio.

6. The unit as recited in claim 1 wherein the broadcast transmission is generated in response to the compact disc identifier and the user identifier.

7. The method of displaying compact disc data for a compact disc accessed by a compact disc player, the method comprising:
when the compact disc data is stored in a unit including the compact disc player, displaying the compact disc data;
when the compact disc data is not stored in the unit including the compact disc player, applying a user identifier and a compact disc identifier to a remote data base;
retrieving compact disc data form the remote data base indexed by the compact disc identifier;
generating a broadcast transmission including the compact disc data and the user identifier;
receiving the broadcast transmission by the unit including the compact disc player; and
providing the compact disc data to a user when the user identifier is present in the broadcast transmission.

8. The method as recited in claim 7 further comprising the step of storing the compact disc data in the broadcast transmission having the user identifier.

9. The method as recited in claim 8 wherein the receiving and the storing are performed by a digital radio.

10. A system for displaying compact disc data, the system comprising:
a compact disc player, the compact disc player including apparatus to retrieve a compact disc identifier from a compact disc;
apparatus for generating a compact disc identifier signal group and a user identifier signal group;
a transmitter unit having a data base, the transmitter unit responsive to the compact disc identifier for retrieving compact disc data related to the identified compact disc, the transmitter unit generating a broadcast transmission including the compact disc data and the user identifier;
a radio receiver for receiving broadcast transmissions;
a processing apparatus for identifying a broadcast transmission including the user identifier, the processing apparatus storing compact disc data in the broadcast transmission that includes the user identification; and
an output unit, the processing apparatus applying at least a portion of the compact disc data to the output unit.

11. The system as recited in claim 10 wherein the data provided the user includes track information for a track being accessed by the compact disc player.

12. The system as recited in claim 10 wherein the processing apparatus and the receiver unit are included in a digital radio.

13. The system as recited in claim 10 wherein the processing apparatus stores the compact disc data when the broadcast transmission includes the used identifier.

14. The system as recited in claim 13 wherein, when the compact disc data is stored in the processing apparatus, the compact disc data is retrieved from the processing apparatus and applied to the output unit unit.

15. The system as recited in claim 14 wherein the output unit is part of the compact disc player.

16. The system as recited in claim 10 wherein the output unit is selected from the group consisting of a display device and a audio output device.

17. A method of providing compact disc information related to a compact disc accessed by a compact disc player in a compact disc player/digital radio unit, the method comprising:
receiving compact disc information broadcast from a station by the digital radio unit;
storing the broadcast disc information;
in response to an access of compact disc by a compact disc player, retrieving stored compact disc information; and
applying the retrieved information to a display unit.

18. The method as recited in claim 17 wherein the broadcast compact disc information includes compact disc information for a multiplicity of compact discs.

19. The method as recited in claim 18 wherein receiving compact disc information includes receiving compact disc information when the digital radio unit is in an inactive mode.
